(19) United States
(12) Patent Application Publication
(10) Pub. No.: US 2010/0005494 A1
(43) Pub. Date: Jan. 7, 2010

(54) ADMINISTERING DIGITAL MEDIA STREAMS

(75) Inventor: James G. McLean, Fuquay-Varina, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/165,683

(22) Filed: Jul. 1, 2008

(51) Int. Cl. G06F 3/00

(52) U.S. Cl. 725/58

(57) ABSTRACT

Methods, apparatus, and products for administering digital media streams by a media display device including: receiving from a digital media provider a digital media stream including content of a plurality of channels, identifying among the plurality of channels one or more channels for caching; caching content of the one or more identified channels, the content of each of the identified channels including a marker identifying a beginning location of a segment of content; and responsive to a user's selection of a first one of the cached channels, displaying the content of the first channel beginning at the location identified by the marker.

### BACKGROUND OF THE INVENTION

1. Field of the Invention

The field of the invention is data processing, or, more specifically, methods, apparatus, and products for administering digital media streams.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Computers today are often incorporated in various devices found in the home as well as the office including devices that display media content, such as for example, televisions, digital video recorders, digital cable set-top-boxes, and the like. Such devices may be used to display content of multichannel digital media streams, such as satellite television, satellite radio, digital cable and the like. Some users of such devices may ‘surf’ the channels, that is, make many selections of different channels often. In today's media display devices, content displayed from the different channels selected during surfing is the most current content of the stream often beginning at a point in a television show other than the beginning, at a point other than the beginning of a song, at a point other than the beginning of a news story, or the like. That is, the content displayed is not displayed beginning at any logical segment of the content, but is instead only displayed beginning at the most recently received content. User's then receive, through display of the content, only fragments of segments—fragments of songs, fragments of television shows, fragments of movies, fragments of news stories, and so on.

### SUMMARY OF THE INVENTION

Methods, apparatus, and products for administering digital media streams by a media display device including: receiving from a digital media provider a digital media stream including content of a plurality of channels, identifying among the plurality of channels one or more channels for caching; caching content of the one or more identified channels, the content of each of the identified channels including a marker identifying a beginning location of a segment of content; and responsive to a user's selection of a first one of the cached channels, displaying the content of the first channel beginning at the location identified by the marker.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system for administering digital media streams by a media display device according to embodiments of the present invention.

FIG. 2 sets forth a flow chart illustrating an exemplary method for administering digital media streams according to embodiments of the present invention.

FIG. 3 sets forth a flow chart illustrating a further exemplary method for administering digital media streams according to embodiments of the present invention.

FIG. 4 sets forth a flow chart illustrating a further exemplary method for administering digital media streams according to embodiments of the present invention.

FIG. 5 sets forth a flow chart illustrating a further exemplary method for administering digital media streams according to embodiments of the present invention.

### DETAILED DESCRIPTION OF EXEMPLARY EMBODIMENTS

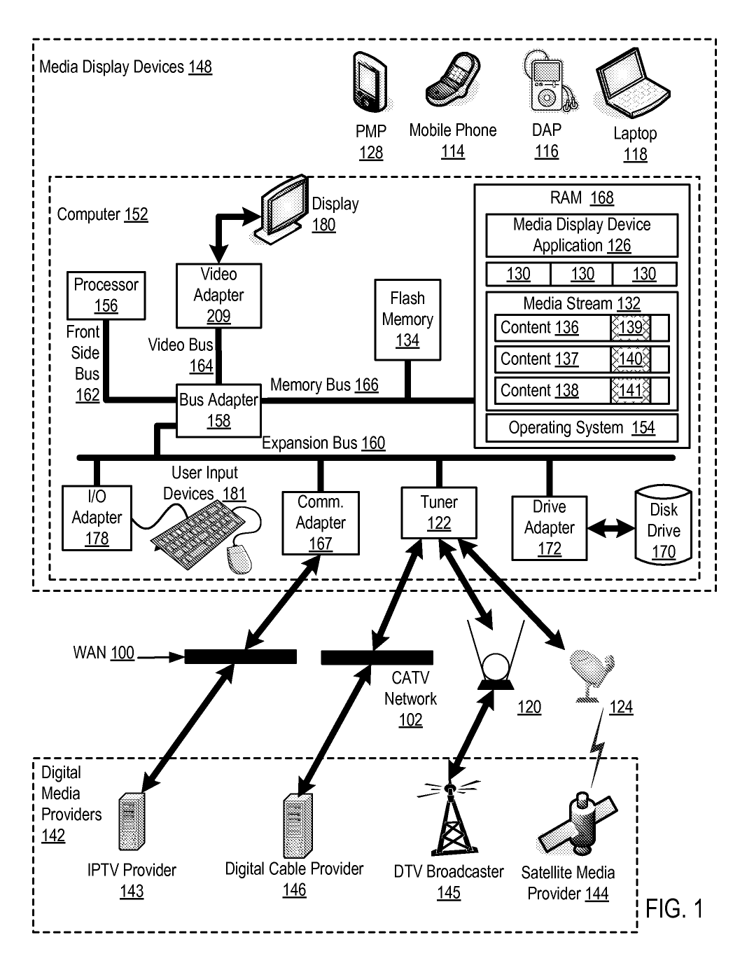

Exemplary methods, apparatus, and products for administering digital media streams in accordance with the present invention are described with reference to the accompanying drawings, beginning with FIG. 1. FIG. 1 sets forth a functional block diagram of an exemplary system for administering digital media streams by a media display device according to embodiments of the present invention.

A digital media stream is content (212) of a multiple channels that is delivered to a media display device during display or playback of the content. Content may include digital audio content, digital video content or a combination of digital audio and video content. Because content may include both audio and video content, ‘displaying’ as the term is used in this specification may include displaying video on a display device, such as a computer monitor or a television, or playing audio through an audio playback device, that is, speakers or headphones. In some embodiments audio content may be ‘displayed,’ that is, played, through speakers installed in a computer monitor or television.

A ‘channel,’ as the term is used in this specification, represents a unique stream of content within a digital media stream. One digital media stream may include many channels, that is, many unique streams of content. Consider, as an example, a digital, satellite radio stream in which audio content of 10 different channels is received by a media display device. Each channel represents one of 10 unique streams of content within the digital, satellite radio stream.

A media display device is an aggregation of computer hardware and software capable of administering digital media streams according to embodiments of the present invention. The system of FIG. 1 includes several example media display devices (148) including, the portable media player (128), mobile phone (114), digital audio player (116), laptop (118), and computer (152).

In the system of FIG. 1, each media display device (148) is capable of receiving a digital media stream from one of a number of digital media providers (142). A digital media provider (142) is an entity that provides a digital media stream (132) media display devices, where the digital media stream (132) includes digital audio or video content of a number of channels. Examples of digital media providers (142) in the system of FIG. 1 include:
an Internet Protocol Television (‘IPTV’) provider (143) that transmits audio and video content to media display devices through a wide area network (‘WAN’) (100);
a satellite media provider (144) that transmits audio and video content through satellites in orbit around the earth to a satellite dish receiver (124) connected to a tuner (122) of a media display device;
a Digital Television (‘DTV’) broadcaster (145) that transmits digital television from a broadcasting antenna to an antenna (120) connected to a tuner (122) of a media display device; and
a digital cable provider (146) that transmits digital cable to a tuner (122) of a media display device through a cable television (‘CATV’) network (102).

IPTV is a system in which a digital television service is delivered using Internet Protocol (‘IP’) over a network infrastructure, which may include delivery by a broadband connection. IPTV may be thought of as television content that, instead of being delivered through traditional broadcast and cable formats, is delivered through the technologies used for computer networks. IPTV may be transmitted over the public Internet through a wide area network or through a closed network infrastructure as described below with respect to a digital cable provider.

Satellite media providers (144) may transmit digital media streams to digital media devices through systems of satellite transmitters and receivers. Such digital media streams may include television content, a combination of digital audio and video. Examples of satellite providers that transmit digital media streams including television content include Echostar™ and DirecTV™. Other digital media streams transmitted by satellite providers may include audio content. Examples of satellite providers that transmit digital media streams including audio content include Sirius™ satellite radio and XM™ satellite radio.

Digital television broadcasters may transmit digital television media streams to media display devices in according to a digital television format. One common format used is the ATSC (‘Advanced Television Systems Committee’) format which enables Radio Frequency (‘RF’) transmission of DTV. According to the ATSC format, content of multiple channels may be multiplexed and transmitted in an MPEG transport stream ‘over-the-air’ that is, as an RF transmission.

Digital cable providers (146), such as Cox Communications™, Time Warner Cable™, and the like, may transmit digital cable content in a digital media stream to a media display device (148) in a variety of ways. A digital cable provider, for example, may transmit digital cable content to a media display device over a closed network infrastructure, not the public Internet, as an IPTV stream. Digital cable providers (146) may also provide other services to users in addition to digital cable television content such as digital telephone services, Voice over IP (‘VOIP’), and internet services.

The computer (152) of FIG. 1, an example media display device, includes at least one computer processor (156) or ‘CPU’ as well as random access memory (168) (‘RAM’) which is connected through a high speed memory bus (166) and bus adapter (158) to processor (156) and to other components of the computer (152). Stored in RAM (168) is a media display device application (126), a set of computer program instructions that causes the computer (152) to operate as a media display device in administering digital media streams according to embodiments of the present invention by receiving from a digital media provider (142) a digital media stream (132) including content of a plurality of channels, identifying among the plurality of channels one or more channels for caching; caching content of the one or more identified channels where the content of each of the identified channels includes a marker identifying a beginning location of a segment of content; and responsive to a user's selection of a first one of the cached channels, displaying the content of the first channel beginning at the location identified by the marker.

In the system of FIG. 1, the computer (152) receives from a digital media provider (142) a digital media stream (132) including content (136) of a first channel, content (137) of a second channel, and content (138) of a third channel. The content (136, 137, 138) of each channel includes a marker (139, 140, 141). A marker identifies a beginning location of a segment of content. A segment of content is a portion of content. A segment may be a song, an entire television show, a commercial, a news story, or other portion of content as may occur to those of skill in the art.

A marker may be an explicit marker or may be an inferred marker. An explicit marker is a marker sent along with or embedded in the content of the channel for the sole purpose of identifying a beginning location of a segment of content. Such an explicit marker may be implemented as a particular digital code embedded in the content of the digital media stream that indicates the beginning of a segment of the content, or a pointer sent along with the digital media stream that points to a particular time, frame, or other location in the content of the channel.

As an alternative to an explicit marker, content of a channel may include information from which a marker identifying a beginning location of a segment of the content may be inferred. Content of a channel may include, for example, in addition to the primary digital video or audio content of the channel, meta-data describing the content. Such metadata may be described as a ‘sub-stream’ or ‘sub-channel’ of the channel. Metadata for a channel of a satellite radio stream, for example, may describe a name of a currently playing song, the artist performing the song, the year the song was recorded, the album name, and so on as will occur to those of skill in the art. A marker may be inferred upon a change in such metadata. Consider, for example, that metadata identifying a name of currently playing song changes. The change itself may be considered a marker in content of a channel identifying a beginning location of a segment, a song, in the content of the channel.

The computer (152) in the example of FIG. 1 caches content (136, 137, 138) of the one or more identified channels by storing the content in a buffer (130), or queue, that is, a region of computer allocated for storing content of digital media streams. Caching the content of the identified channels may include demultiplexing the plurality of channels. Demultiplexing the channels extracts the channels from the media stream such that content of the channels may be cached and displayed. In some embodiments caching the content of the identified channels includes decoding the content through use of a codec. A codec is a device or program capable of encoding or decoding a digital data stream or signal. The word codec may be a combination of any of the following: ‘compressor-decompressor,’ ‘coder-decoder,’ or ‘compression/decompression algorithm.’ Decoded content of a channel typically has a larger memory footprint than original encoded content, however, and as such, buffers used to caching such decoded content may be larger than those used to cache encoded content.

Upon a user's selection of a first one of the cached channels, the selection provided to the computer (152) via a user input device (181) such as a remote control for example, the computer (152) of FIG. 1 displays the content of the first channel beginning at the location identified by the marker. That is, the media display device application (126) scans the content of the first channel (136) for the first marker (139) stored in the cache (130), decodes the content through use of a codec, if not previously decoded, and displays the content on a display (180) beginning at the location identified by the marker (139).

Also stored in RAM (168) is an operating system (154). Operating systems useful for administering digital media streams according to embodiments of the present invention include UNIX™, Linux™, Microsoft XP™, Microsoft Vista™, AIX™, IBM's i5/OS™, and others as will occur to those of skill in the art. The operating system (154), media display device application (126), buffers (130), and media stream (132), in the example of FIG. 1, are shown in RAM (168), but many components of such software typically are stored in non-volatile memory also, such as, for example, on a disk drive (170) or in flash memory (134).

The computer (152) of FIG. 1 also includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers that administering digital media streams according to embodiments of the present invention include Integrated Drive Electronics (‘IDE’) adapters, Small Computer System Interface (‘SCSI’) adapters, and others as will occur to those of skill in the art. Non-volatile computer memory also may be implemented as an optical disk drive, electrically erasable programmable read-only memory (so-called ‘EEPROM’ or ‘Flash’ memory) (134), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) for data communications with a data communications network (100), other media display devices (148), and digital media providers (142). Such data communications may be carried out serially through RS-232 connections, through external buses such as a Universal Serial Bus (‘USB’), through data communications data communications networks such as IP data communications networks, and in other ways as will occur to those of skill in the art. Communications adapters implement the hardware level of data communications through which one computer sends data communications to another computer, directly or through a data communications network. Examples of communications adapters useful for administering digital media streams according to embodiments of the present invention include modems for wired dial-up communications, Ethernet (IEEE 802.3) adapters for wired data communications network communications, and 802.11 adapters for wireless data communications network communications.

The arrangement of servers, computers, media display providers, networks, media display devices, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

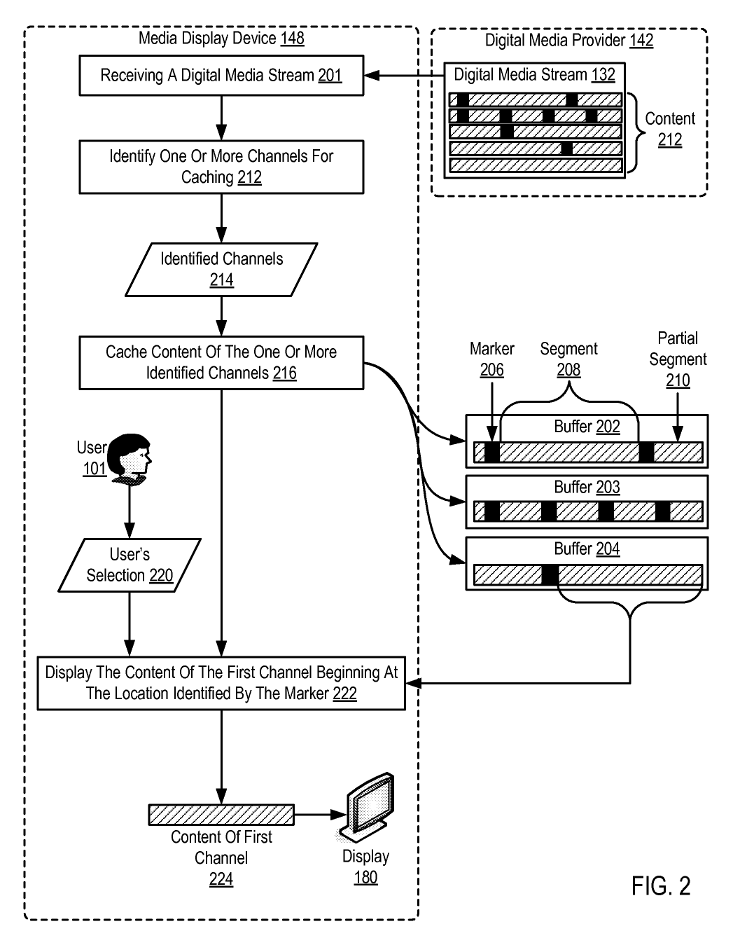

For further explanation, FIG. 2 sets forth a flow chart illustrating an exemplary method for administering digital media streams according to embodiments of the present invention. The method of FIG. 2 includes receiving (201) by a media display device (148) from a digital media provider (142), a digital media stream (132) that includes content (212) of a plurality of channels. As mentioned above, a digital media provider may include digital cable providers, IPTV providers, digital television broadcasters, satellite media providers and the like.

The method of FIG. 2 includes identifying (212) among the plurality of channels one or more channels for caching. Identifying (212) among the plurality of channels one or more channels for caching may be carried in various ways including, for example, accepting from the user (101) an identification of the one or more channels for caching. That is, a user may expressly select, through a graphical user interface provided by the media display device and a user input device such as a remote control, one or more channels for caching. A user may also expressly select one or more channels for caching through a physical device, such as a hardware button on a radio or television designated for use in selecting channels for caching. Such hardware buttons may be implemented in a similar fashion as preset buttons on current car radios.

The method of FIG. 2 also includes caching (216) content of the one or more identified channels (214), the content of each of the identified channels including a marker (206) identifying a beginning location of a segment (208) of content. Caching (216) content of the one or more identified channels (214) may be carried out by demultiplexing the channels and storing the content in of each channel in a buffer (202, 203, 204). The method of FIG. 2 includes three example buffers, one for each of the identified cached channels. Each of the example buffers (202, 203, 204) includes content of a channel which, in turn, includes one or more markers (206) identifying beginning locations of segments (208) of the content.

Responsive to a user's (101) selection (220) of a first one of the cached channels, the method of FIG. 2 continues by displaying (222) the content (224) of the first channel beginning at the location identified by the marker (206). Displaying (222) the content (224) of the first channel beginning at the location identified by the marker (206) may be carried out by, decoding through use of a codec the cached content, if not previously decoded, and displaying video content on a computer display (180), a television, or playing audio content through speakers or headphones.

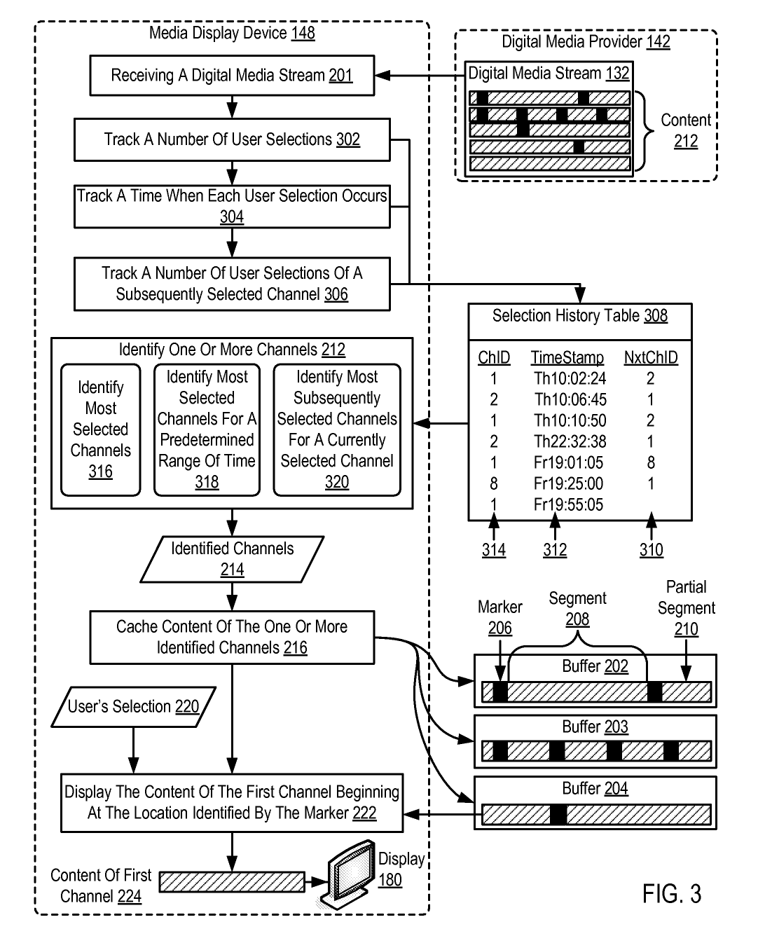

For further explanation, FIG. 3 sets forth a flow chart illustrating a further exemplary method for administering digital media streams according to embodiments of the present invention. The method of FIG. 3 is similar to the method of FIG. 2 including as it does receiving (201) by a media display device (148) from a digital media provider (142), a digital media stream (132) that includes content (212) of a plurality of channels; identifying (212) among the plurality of channels one or more channels for caching; caching (216) content of the one or more identified channels (214), the content of each of the identified channels including a marker (206) identifying a beginning location of a segment (208) of content; and responsive to a user's (101) selection (220) of a first one of the cached channels, displaying (222) the content (224) of the first channel beginning at the location identified by the marker (206).

The method of FIG. 3 differs from the method of FIG. 2, however, in that the method of FIG. 3 includes tracking (302) a number of user selections of each of the plurality of channels; tracking (304) a time when each user selection occurs; and tracking (306), for each of the plurality of channels, a number of user selections of a subsequently selected channel.

Tracking (302) a number of user selections of each of the plurality of channels may be carried out by recording, upon each user selection, a channel identification of the selected channel. The media display device (148) may be configured such that a user selection is recorded only if there is no subsequent selection of another channel within a predetermined amount of time. The amount of time between a selection of a particular channel and a subsequent selection of another channel may be an indication of a user's interest in content of the selected channel. The greater the amount of time, the greater a user's interest in content of the selected channel. Recording selections only if there is no subsequent selection of another channel within a predetermined amount of time insures that the content of possible channels to be cached are channels for which there is a significant user interest.

Tracking (304) a time when each user selection occurs may be carried out by recording a timestamp, upon each user selection, in association with the channel identification of the selected channel. Timestamps may be of any level granularity. A timestamp may only identify a range of times in which the selection occurred, such as 8:00 to 9:00 pm. A timestamp may identify only the hour and minutes when the selection occurred, such as 8:52 pm. A timestamp may identify, along with an hour and minutes, the day of week on which the selection occurred.

Tracking (306), for each of the plurality of channels, a number of user selections of a subsequently selected channel may be carried out by recording for a first selection, upon a subsequent selection, a channel identification of the subsequently selected channel. Consider, as an example, a first selection of channel 1, and a subsequent selection of channel 2. Recording for a first selection, upon a subsequent selection, a channel identification of the subsequently selected channel may include recording for the selection of channel 1, the channel identification ‘2’ upon the selection of channel 2.

In the example of FIG. 3, the number of user selections, the time of each selection, and the subsequently selected channel are tracked in a selection history table (308). The selection history table includes a column of channel identifications (314) of the selected channel for selection, a column of timestamps (312), and a column of channel identifications of subsequently selected channels for each selection. Each record in the selection history table (308) of FIG. 3 represents a user selection. The first record in the example selection history table (308), for example, represents a user selection of channel 1 which occurred at 10:02:24 on Thursday with a subsequent user selection of channel 2.

In the example of FIG. 3, subsequently selected channels are identified in the selection history table (308) in a column (310) for clarity. Readers of skill in the art will recognize, however, that subsequently selected channels may be inferred from other information stored of the selected history table. Subsequently selected channels may be inferred in dependence upon timestamps of selections, or the order in which selections are recorded in the table. The channel identification of each selection record in the selection history table (308) is, for a previous selection record, the channel identification of a subsequently selected channel.

Readers of skill in the art will also recognize that any number of tables, lists, records, and data structures may be used in tracking a number of user selections, a time when each user selection occurs, and subsequently selected channel according to embodiments of the present invention. The selection history table (308) of FIG. 3 including only three columns is just one example data structure, described here for clarity, which may be used in tracking such selection information.

In the method of FIG. 3, identifying (212) among the plurality of channels one or more channels for caching may be carried out in a number of ways including identifying (316) for caching one or more most selected channels. Identifying (316) for caching one or more most selected channels may be carried out by counting for each channel identification, a number of selection records that include the channel identification and identifying a predefined number of channel identifications having the highest count. A predefined number represents the total number of channels to be cached. The predefined number for example may represent that three channels are to be cached and as such, the media display device may identify 3 channel identifications have the highest count. In the example of FIG. 3, counting, for each channel identification, a number of selection records that include the channel identification results in a count of three selections of channel 1 and two selections of channel 2. If the media display device is configured to identify only one channel having the highest count, the media display device (148) will identify channel 1, with three selections, as a channel to be cached.

In the method of FIG. 3, identifying (212) among the plurality of channels one or more channels for caching may also be carried out by identifying (318) for caching one or more most selected channels for a predetermined range of time. Identifying (318) for caching one or more most selected channels for a predetermined range of time may be carried out by counting, for each channel identification, selection records of the selection history table (308) having a timestamp within the predetermined range of time and identifying a predefined number of channel identifications having the highest count. Consider as an example, that predetermined range of time is Fridays from 19:00:00 to 19:59:99 and the predefined number of channel identifications is one. Identifying (318) for caching one or more most selected channels for Fridays from 19:00:00 to 19:59:99 may be carried out by counting, for each channel identification, selection records of the selection history table (308) having a timestamp on a Friday from 19:00:00 to 19:59:99—two selections for channel 1 and one selection for channel 8—and identifying the channel identification having the highest count, channel 1.

In the method of FIG. 3, identifying (212) among the plurality of channels one or more channels for caching may also be carried out by identifying (320) for caching one or more of the most subsequently selected channels for a currently selected channel. Identifying (320) for caching one or more of the most subsequently selected channels for a currently selected channel may be carried out for the currently selected channel by counting, for each non-selected channel identification, a number of selection records including the non-selected channel identification as a subsequently selected channel and identifying a predefined number of the non-selected channel identifications having the highest count. Consider as an example that the channel identification of the currently selected channel is 1. For the currently selected channel 1, counting, for each non-selected channel identification, a number of selection records in the selection history table (308) that include the non-selected channel identification as a subsequently selected channel results in a count of 2 for the non-selected channel 2 and a count of one for the non-selected channel 8. That is, there are two selection records indicating that the channel 2 was selected subsequent to the channel 1 and there is one selection record indicating that the channel 8 was selected subsequent to the channel 1. Identifying the most subsequently selected channels for a currently selected channels may be useful for users that regularly oscillate selections between one of a few channels. Consider, for example, that a user regularly oscillates selections of channel 8, 9, and 10. When a user selects channel 8, the media display device may identify as channels to cache, channels 9 and 10.

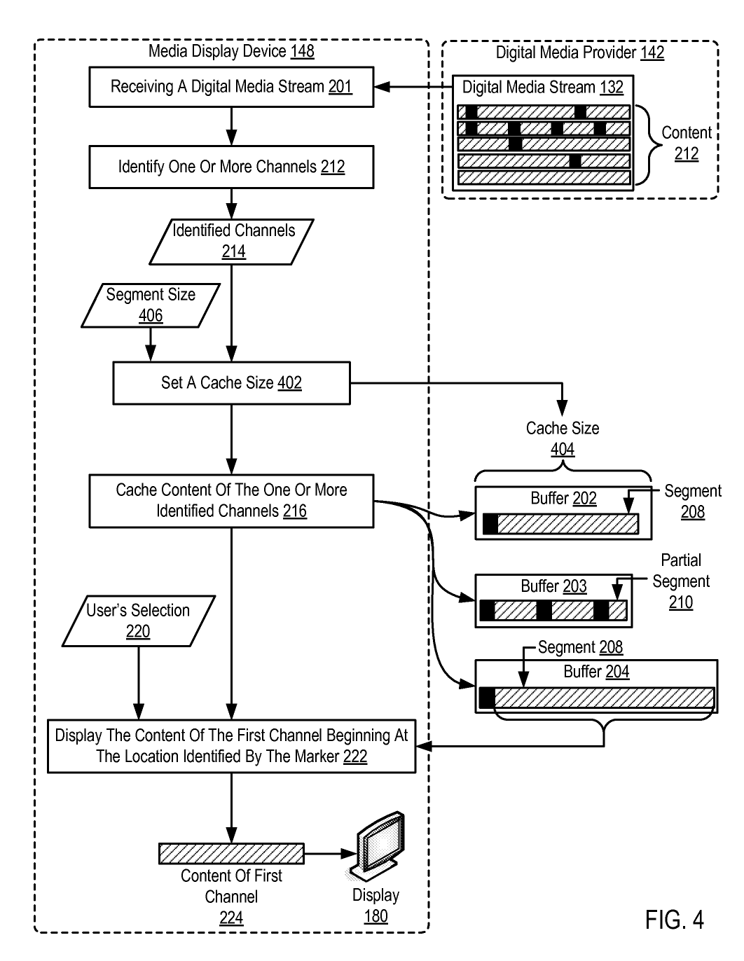

For further explanation, FIG. 4 sets forth a flow chart illustrating a further exemplary method for administering digital media streams according to embodiments of the present invention. The method of FIG. 4 is similar to the method of FIG. 2 including as it does receiving (201) by a media display device (148) from a digital media provider (142), a digital media stream (132) that includes content (212) of a plurality of channels; identifying (212) among the plurality of channels one or more channels for caching; caching (216) content of the one or more identified channels (214), the content of each of the identified channels including a marker (206) identifying a beginning location of a segment (208) of content; and responsive to a user's (101) selection (220) of a first one of the cached channels, displaying (222) the content (224) of the first channel beginning at the location identified by the marker (206).

The method of FIG. 4 differs from the method of FIG. 2, however, in that the method of FIG. 4 includes setting (402), for each identified channel (214) in dependence upon segment size (406) of the content of the identified channel, a cache size (404) for caching the content of the identified channel. setting (402) , for each identified channel (214) in dependence upon segment size (406) of the content of the identified channel, a cache size (404) for caching the content of the identified channel may be carried out by setting a length for each buffer (202, 203, 204) in which content of the channels is cached. Segment size may be dependent upon a type of content of each channel. Audio content comprising songs, for example, may have segments of sizes on the order of 100 kilobytes to 5 megabyte range, while television content may be on the order of 100 megabytes to several gigabytes in size. The media display device may also be configured to cache a particular number of segments, such as the last three satellite radio songs for example. The buffer (202) is configured to store only one segment (208) of video content, a 30 minute long television show. The size (404) of the buffer (202) is greater than the size of the buffer (203) which is configured to store the last two segments of audio content, 5 minute-long satellite radio songs. The size (404) of the buffer (204) is the greates among the buffers. The buffer (204) is configured to store one segment of video and audio content, a two hour long movie.

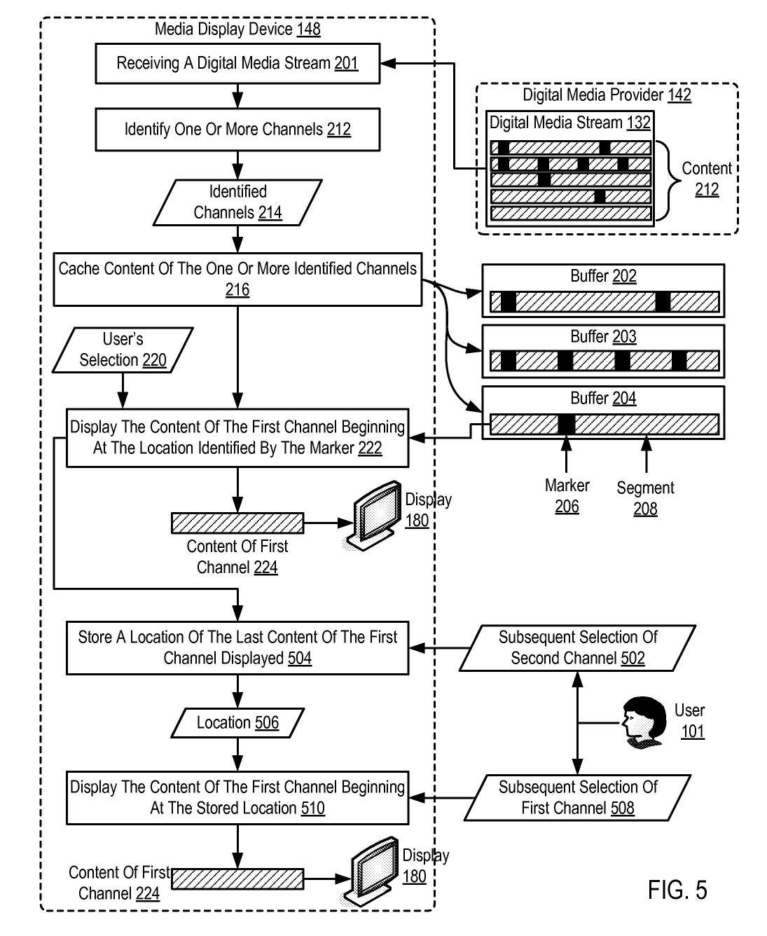

For further explanation, FIG. 5 sets forth a flow chart illustrating a further exemplary method for administering digital media streams according to embodiments of the present invention. The method of FIG. 5 is similar to the method of FIG. 2 including as it does receiving (201) by a media display device (148) from a digital media provider (142), a digital media stream (132) that includes content (212) of a plurality of channels; identifying (212) among the plurality of channels one or more channels for caching; caching (216) content of the one or more identified channels (214), the content of each of the identified channels including a marker (206) identifying a beginning location of a segment (208) of content; and responsive to a user's (101) selection (220) of a first one of the cached channels, displaying (222) the content (224) of the first channel beginning at the location identified by the marker (206).

The method of FIG. 5 differs from the method of FIG. 2, however, in that responsive to the user's (101) subsequent selection (502) of a second channel, the method of FIG. 5 continues by storing (504) a location (506) of the last content of the first channel displayed prior to the user's subsequent selection of the second channel. Storing (504) a location (506) of the last content of the first channel displayed prior to the user's subsequent selection of the second channel may be carried out by storing a time from which to begin playing back a song of the first channel, storing a frame number from which to begin displaying a video of the first channel, and so on. Responsive to the user's (101) subsequent selection (508) of the first channel, that is, upon returning to the first channel from the second channel, the method of FIG. 5 continues by displaying (510) the content (224) of the first channel beginning at the stored location (506). Such a stored location may be used instead of the first marker in a buffer as a location from which to begin displaying the content. In this way, a user may return to the last displayed location rather than a previous marker, reducing redundant display the same content.

As an alternative to displaying the content of the first channel beginning from the stored location, the method may include caching a next marker in the content of the first channel and responsive to another subsequent selection of the cached channel, displaying the content of the cached channel beginning at the location identified by the next marker, not the stored location. That is, if a user has selected the second channel for an amount of time so long that one or more subsequent segments of the content of the first channel are cached, the media display device may display the content of the first channel upon returning to the first channel from a marker identifying the beginning location of one of the subsequent segments, rather than the stored location. Consider, for example, embodiments in which a user switches from a first to a second channel with no subsequent selections for several hours. Displaying the content of the cached channel beginning at the location identified by the next marker, not the stored location, may be useful in these embodiments because allocation of computer memory for caching channels may be restricted such that the content of the first channel over the several hours cannot be cached and the location in the content is flushed from the cache upon returning to the first channel, a user may not desire to begin viewing such stale content of the first channel, or for other reasons as will occur to those of skill in the art.

Exemplary embodiments of the present invention are described largely in the context of a fully functional computer system for administering digital media streams. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of administering digital media streams by a media display device, the media display device receiving from a digital media provider a digital media stream including content of a plurality of channels, the method comprising:
identifying among the plurality of channels one or more channels for caching;
caching content of the one or more identified channels, the content of each of the identified channels including a marker identifying a beginning location of a segment of content; and
responsive to a user's selection of a first one of the cached channels, displaying the content of the first channel beginning at the location identified by the marker.

2. The method of claim 1 further comprising:
setting, for each identified channel in dependence upon segment size of the content of the identified channel, a cache size for caching the content of the identified channel.

3. The method of claim 1 further comprising:
responsive to the user's subsequent selection of a second channel, storing a location of the last content of the first channel displayed prior to the user's subsequent selection of the second channel; and responsive to the user's subsequent selection of the first channel, displaying the content of the first channel beginning at the stored location.

4. The method of claim 1 further comprising:
tracking a number of user selections of each of the plurality of channels;
wherein identifying among the plurality of channels one or more channels for caching further comprises identifying for caching one or more most selected channels.

5. The method of claim 1 further comprising:
tracking a number of user selections of each of the plurality of channels and a time when each user selection occurs;
wherein identifying among the plurality of channels one or more channels for caching further comprises identifying for caching one or more most selected channels for a predetermined range of time.

6. The method of claim 1 further comprising:
tracking, for each of the plurality of channels, a number of user selections of a subsequently selected channel;
wherein identifying among the plurality of channels one or more channels for caching further comprises identifying for caching one or more of the most subsequently selected channels for a currently selected channel.

7. An apparatus for administering digital media streams, the apparatus receiving from a digital media provider a digital media stream including content of a plurality of channels, the apparatus comprising a computer processor, a computer memory operatively coupled to the computer processor, the computer memory having disposed within it computer program instructions capable of:
identifying among the plurality of channels one or more channels for caching;
caching content of the one or more identified channels, the content of each of the identified channels including a marker identifying a beginning location of a segment of content; and
responsive to a user's selection of a first one of the cached channels, displaying the content of the first channel beginning at the location identified by the marker.

8. The apparatus of claim 7 further comprising computer program instructions capable of:
setting, for each identified channel in dependence upon segment size of the content of the identified channel, a cache size for caching the content of the identified channel.

9. The apparatus of claim 7 further comprising computer program instructions capable of:
responsive to the user's subsequent selection of a second channel, storing a location of the last content of the first channel displayed prior to the user's subsequent selection of the second channel; and responsive to the user's subsequent selection of the first channel, displaying the content of the first channel beginning at the stored location.

10. The apparatus of claim 7 further comprising computer program instructions capable of:
tracking a number of user selections of each of the plurality of channels;
wherein identifying among the plurality of channels one or more channels for caching further comprises identifying for caching one or more most selected channels.

11. The apparatus of claim 7 further comprising computer program instructions capable of:
tracking a number of user selections of each of the plurality of channels and a time when each user selection occurs;
wherein identifying among the plurality of channels one or more channels for caching further comprises identifying for caching one or more most selected channels for a predetermined range of time.

12. The apparatus of claim 7 further comprising computer program instructions capable of:
tracking, for each of the plurality of channels, a number of user selections of a subsequently selected channel;
wherein identifying among the plurality of channels one or more channels for caching further comprises identifying for caching one or more of the most subsequently selected channels for a currently selected channel.

13. A computer program product for administering digital media streams by a media display device, the media display device receiving from a digital media provider a digital media stream including content of a plurality of channels, the computer program product disposed in a computer readable, signal bearing medium, the computer program product comprising computer program instructions capable of:
identifying among the plurality of channels one or more channels for caching;
caching content of the one or more identified channels, the content of each of the identified channels including a marker identifying a beginning location of a segment of content; and
responsive to a user's selection of a first one of the cached channels, displaying the content of the first channel beginning at the location identified by the marker.

14. The computer program product of claim 13 further comprising computer program instructions capable of:
setting, for each identified channel in dependence upon segment size of the content of the identified channel, a cache size for caching the content of the identified channel.

15. The computer program product of claim 13 further comprising computer program instructions capable of:
responsive to the user's subsequent selection of a second channel, storing a location of the last content of the first channel displayed prior to the user's subsequent selection of the second channel; and responsive to the user's subsequent selection of the first channel, displaying the content of the first channel beginning at the stored location.

16. The computer program product of claim 13 further comprising computer program instructions capable of:
tracking a number of user selections of each of the plurality of channels;
wherein identifying among the plurality of channels one or more channels for caching further comprises identifying for caching one or more most selected channels.

17. The computer program product of claim 13 further comprising computer program instructions capable of:
tracking a number of user selections of each of the plurality of channels and a time when each user selection occurs;
wherein identifying among the plurality of channels one or more channels for caching further comprises identifying for caching one or more most selected channels for a predetermined range of time.

18. The computer program product of claim 13 further comprising computer program instructions capable of:
tracking, for each of the plurality of channels, a number of user selections of a subsequently selected channel;
wherein identifying among the plurality of channels one or more channels for caching further comprises identifying for caching one or more of the most subsequently selected channels for a currently selected channel.

19. The computer program product of claim 13 wherein the signal bearing medium comprises a recordable medium.

20. The computer program product of claim 13 wherein the signal bearing medium comprises a transmission medium.
